(19) United States
(12) Patent Application Publication
(10) Pub. No.: US 2007/0094355 A1
(43) Pub. Date: Apr. 26, 2007

(54) Click fraud prevention method and apparatus

(76) Inventors: Suresh Mulakala, Dallas, TX (US); Prakash Mulakala, Alpharetta, GA (US)

Correspondence Address: Wilson Daniel Swayze, Jr, 3804 Clearwater Ct., Plano, TX, 75025, US

(21) Appl. No.: 11/256,738

(22) Filed: Oct. 24, 2005

(51) Int. Cl. G06F 15/16

(52) U.S. Cl. 709/219

(57) ABSTRACT

A method and apparatus for accepting an access request from a client computer connected to a server computer through a network including receiving the access request for the server computer from the client computer, generating a predetermined number of random characters to form a string in the server computer in response to the access request, forming a decoy string of characters different than said riddle and an answer corresponding to said riddle, placing the riddle on the display of an output device of the client computer, placing the decoy string and the answer on buttons or a list menu of a display of an output device of the client computer, and determining if the answer to the riddle is correct.

### FIELD OF THE INVENTION

This invention relates generally to accessing computer systems and more particularly to accepting requests of a server computer by authenticating human users.

### BACKGROUND OF THE INVENTION

The Internet is a highly-distributed computer network that connects computers all over the world. The computers of the Internet can be classified either as client computers or as server computers. The operators of the server computers provide services and products for the client computers. The types of client computers and server computers are numerous and will not be discussed here in detail.

The providers of Internet services and products may want to restrict access of the server computers to human beings. These providers for various reasons do not want access to their server computers open to other computers which are driven by automated software. That is, these providers want access denied to automated ‘agents’ operating on the behalf of users. An agent is a software program or script generator that can mimic the access of a human user. The problem with these agents is that they may be designed to behave in a malicious or destructive manner. Automated agents may and can generate service requests at a rate that far exceeds the requests made by a human user. Consequently, these automated agents at the very least can monopolize the server computers and deny access from human users.

Another reason that the providers of Internet services and products may want to restrict access of the server computers to human beings is advertising. Advertising has no effect on automated agents since the human element is missing. On the Internet, advertising revenue may be based on the number of times that the advertisements are displayed and when service requests are made. Consequently, advertising money is wasted on service requests made by these automated agents. Furthermore, a malicious user may target specific service requests knowing that a particular advertiser will be charged based upon the service requests. As a result, the particular advertiser has a large expense as a result of the malicious user targeting in effect the particular advertiser. This is known as click fraud.

Yet, another reason that access should be limited to human users is ‘spamming’. On the Internet, spamming is a term used to describe mostly useless electronic messages such as e-mail. With spamming, a spamming agent sends a single unsolicited e-mail to thousands of e-mail addresses. While a few people may have interest in such e-mail, the vast majority of spamming e-mails is not wanted and is considered to be a nuisance.

Search engines may also be the target of these service requests. Again, a malicious user may desire to request the search engine to index incorrectly many useless or deceptive web pages to artificially boost the viability of a particular product or service. Although, this type of page boosting cannot be completely eliminated since human users can perform this action without the aid of automated service requests, automated service requests can far exceed in number one that a human user could perform, and the automated service requests represent a far greater potential for abuse than the human users.

The information gathering potential of automated service requests represents an additional problem for providers of services and products on the Internet. With automated agents, it is possible to copy the information of the services and products of the provider and use this information to set up a competitive service or product without the knowledge or consent of the original provider. Some malicious users send phony links with an e-mail so that when an innocent user accesses the phony links, the malicious users obtain personal information of the innocent user without the permission of the innocent user.

In all these examples, it is difficult to distinguish between the automated service requests generated by software driven computers and a service request generated by a human being. It is difficult to trace a service request back to the source both physically and electronically. It is easy in today's Internet to set up a web page, use this web page as the source for automated service requests and then abandoned the web page when the automated service requests are detected.

This problem has been addressed to a limited degree by U.S. Pat. No. 6,195,698 incorporated by reference which describes a method and apparatus by which a server computer receives an access request from a client computer from the Internet and generates in response a predetermined number of humane perceptible random characters such as letters and numbers formed in a string in the server computer. The string is randomly modified either visually or audibly to form a riddle, and the characters can be visually distorted or overlaid on a random ‘noisy’ background such as a maze. In response to the riddle, the client computer responds with an answer to the riddle. If the answer is correct within a predetermined amount of time and then the access request is accepted. However, this procedure is cumbersome in that the answer must be typed in by the human user. This requires a time-consuming action that is not consistent with today's click and go attitudes.

### SUMMARY OF THE INVENTION

The present invention employs an extra click security concept to prevent click fraud, spam or identity fraud, and phishing can be reduced or completely eliminated. The extra click security introduces a sufficient amount of human interaction so that automated agents are prevented from accessing the server client. When access is desired to for example a web site, the extra click security is activated and invokes a pop-up window or a menu in accordance with the particular implementation to authenticate that a human user and not that an automated agent is requesting access. A riddle is generated and presented to the requester in the pop-up window, and a plurality of possible answers is displayed. Among the possible answers is a correct answer that matches the riddle that has been generated. The possible answers may be displayed on buttons and may be formed to be close in appearance to the correct answer but not an exact duplicate of the riddle. Forming the possible answers in this way will confuse the automatic agent and heightened security. The human user will quickly detect the correct answer and click (the extra click) on the appropriate button showing the correct answer and receive access to the server client. There is no need to type in the answer, and consequently the human user saves a significant amount of time. It is within the scope of the present invention to randomize the position in the pop-up display of the correct answer to increase the difficulty of the automated agent from detecting the correct answer. Additionally, the number and size of buttons can be randomized again to deter the automated agent. The present invention reduces automatic registrations and helps to prevent the creation of e-mails automatically to be used as spam. Additionally the present invention reduces click fraud on web-based advertising to help prevent customers from paying excess advertising bills.

### BREIF DESCRIPTION OF THE DRAWINGS

FIG. 1 shows a widely distributed network of computers;

FIG. 2 shows a pop-up block of the present invention;

FIG. 3 shows a list block item;

FIG. 4 shows a flow chart of the present invention.

### DETAILED DESCRIPTION

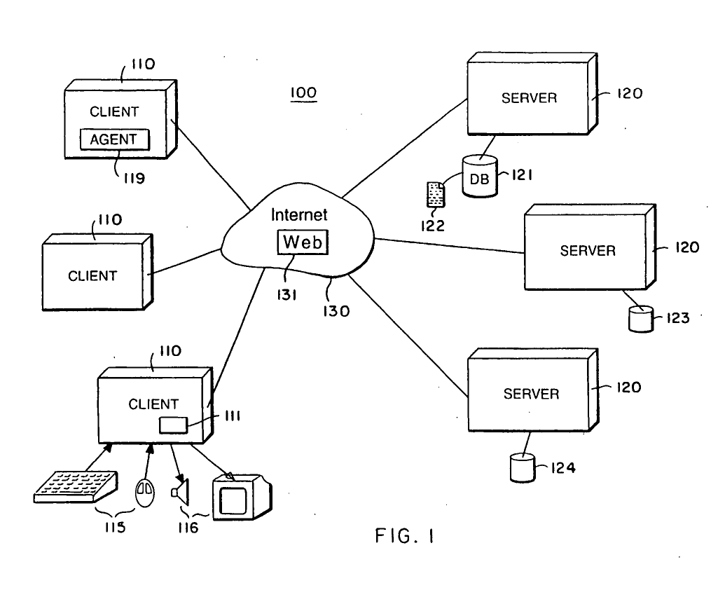

FIG. 1 shows a widely distributed network of computers 100 which includes client computers 110 connected to server computers 120 by a network 130 for example the Internet. The server computers 120 provide ‘Internet’ services and products to users of the client computers 110. The Internet includes an application interface referred to as the World Wide Web 131, and the computers 110 communicate with each other using messages that include addresses of sending and receiving computers in which these addresses are called Internet protocol addresses.

The client computers 110 could be personal computers, workstations or laptops. Typically, the client computers 110 can be equipped with input devices 115 such as a keyboard and with a mouse and output devices 116 such as a loudspeaker and display terminal. Software in the form of a Web browser 111, for example, the Netscape Navigator or the Microsoft Internet Explorer acts with the I/O devices 115-116 to provide an interface between the client user and the Web 131.

In order to generate riddles, human perceptible random characters are generated and a small number of these human perceptible random characters is randomly chosen to form a string. The number of human perceptible random characters should be sufficiently great to prevent an automated agent from solving the riddles by using brute force, guessing techniques. The appearance of the string may be randomized by several techniques. For example, each character can be displayed in a different random selected font, or the spacing between each character can be varied in accordance with the size of the character and the distance from the baseline to the character. Some randomly chosen characters can be spaced so close together that they partially intersect. Each character as well as the entire string can be randomly stretched or distorted in any number of ways. The string can follow a random path rather than a straight path, and the characters of the string could follow a curved path for example like the character C. The string could be randomly rotated around a randomly selected point for example the string might be mirror reversed.

The background of the string could be confusingly random; one example might be a random maze. The characters of the string might be chosen from different colors.

Other strings referred to as decoy strings are generated and may be confusingly similar to the original string. The decoy strings may be different from the original string by only one or two characters or may be completely different so that the automated agents have an increasingly difficult time identifying the original string. A display for the video monitor is prepared. The riddle is displayed and may be displayed along with instructions on how to submit the answer, for example that the human user is to choose a button which displays the answer. The display may have a plurality of buttons, each with the answer or a decoy string. As soon as the display is placed on the video monitor, a timer is started and used to avoid giving the automated agents sufficient time to determine the button with the answer. Once the timer has expired, the riddle, the answer and decoy string are refreshed and changed to prevent the automated agents from determining the button having the correct answer. The timer should be sufficiently long so as the human user can comfortably recognize the button with the answer and use his/her mouse or other input device to activate the button with the answer. The process may be repeated a predetermined number of times for example three times, and after the predetermined number of times, access is denied because the server computer has determined that the user is an automated agent. The user must log on to the site again in order to gain access. The display may have advertising or other types of indicia positioned in the areas of the display where the buttons are not located.

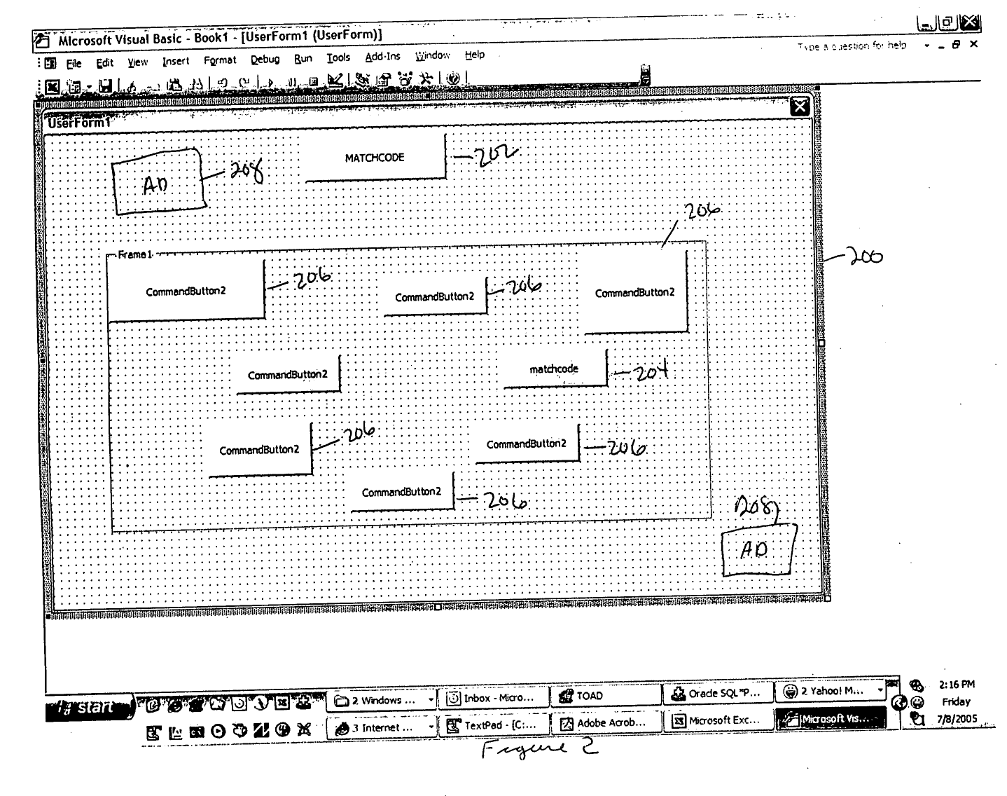

The riddle and answer could be characters that are not letters. The riddle and answer could be some object for example a bird. The riddle and answer may not be exactly the same but could be related by some relationship that is known to all or almost all humans. The riddle could be a picture of a bird, for example a finch, and the answer could be a picture of a different bird in this example, the bird could be a cardinal. The automatic agent should not be able to determine the bird relationship common to the riddle and answer. In contrast, the human user would recognize the relationship between the finch and the cardinal, and the human user would choose the correct answer in this case the cardinal. The relationship could be obtained from many areas including advertisement or brands. FIG. 2 illustrates a pop-up window 200 to form a display showing the riddle 202, the correct answer 204 and the decoy strings 206. The riddle 202 is shown with the characters ‘match code’ as the original string, and the answer 204 is shown with the string of characters ‘match code’ and positioned on a button for the user to activate. The remaining buttons are shown with the decoy string 206, showing the string characters ′command button 2. The decoy string 206 may be different characters on each button forming different strings to confuse the automated agent. The size of the buttons could be random such as shown in FIG. 2.

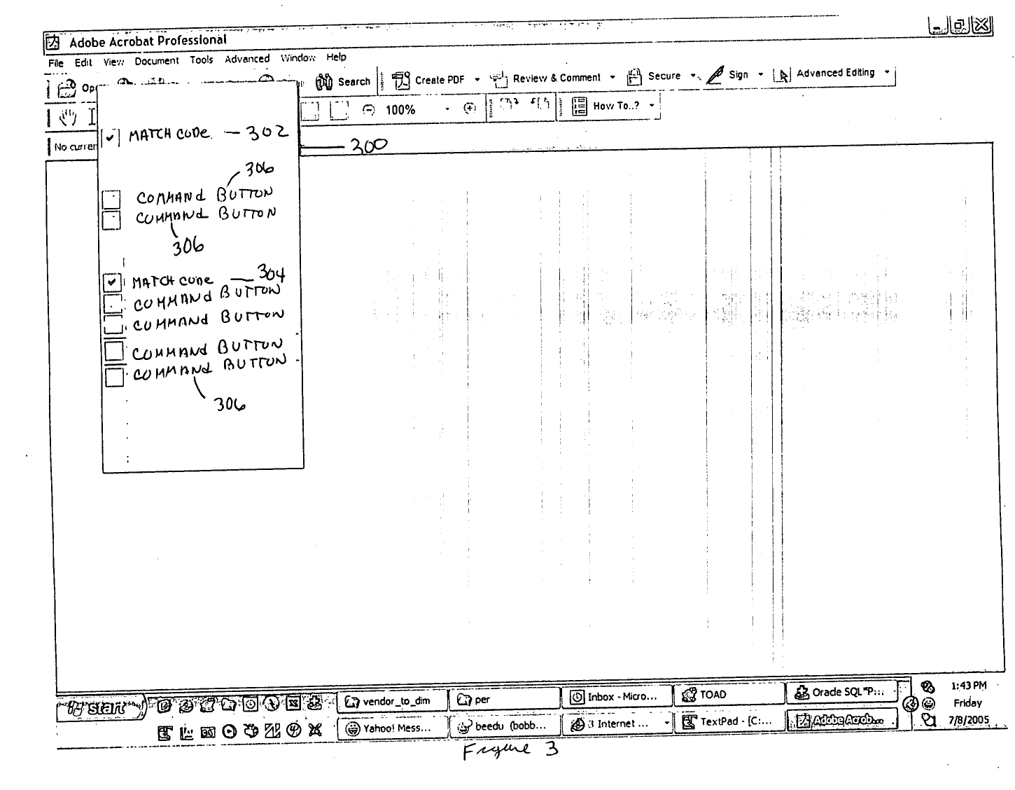

FIG. 3 illustrates a list menu 300 which performs a similar function to pop-up window 200 to permit a user to gain access to a server computer 120. As discussed before, a riddle 302 is generated from characters formed into a string. Although FIG. 3 shows the riddle 302 at the top of the list menu 300, other locations for the riddle 302 are possible. The riddle 302 is shown as the string of characters ‘match code’. Below, the riddle 302 is a random combination of decoy strings 306 and the answer 304. The human user should see the riddle 302 and find the answer 304 and place a check mark next to the answer 304 by using the mouse or other input device. The answer to the riddle is correct, and the human user would be then given access to the server computer 120. If the automated agent places a check mark next to the decoy string 306, then access to the server computer 120 would be denied.

If the owner of the server computer implements a security feature as described herein on a link, advertisement or button, the link advertisement or button will be registered in a central database and assigned a unique identifier such as a logo or symbol. This unique identifier is shown to any user when the user places his mouse over the link, advertisement or button so that the user recognizes the unique identifier and can be assured that the link, advertisement or button is genuine. As a result, this unique identifier can become a brand four authentic and secured service, helping to eliminating identity fraud. The unique identifier can be relied on by the user that the link, advertisement or button is genuine.

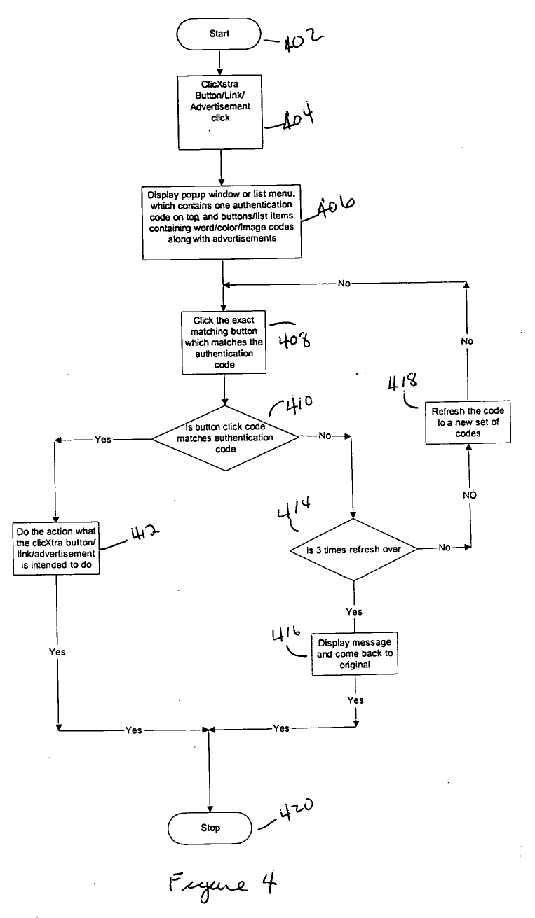

FIG. 4 illustrates a flow chart showing the steps of the present invention. In step 402, the user starts the operation of the present invention. In step 404, the human user or the automated agent clicks on the address for the web site for example and instead of providing immediate access to the web site, a display pop-up window 200 or list menu 300 is displayed to the to the automated agent or the human user. As described before, the pop-up window 200 or list display 300 shows the original string or riddle 202,302 as an authentication code for access to the desired web site. Additionally displayed are buttons having the decoy strings 206, 306 and the answer 204, 304 of the original string and may include advertisements 208.

In step 408, the agent clicks on one of the buttons which may display the decoy string or the answer. In step 410, it is determined if the selected button is the correct answer of the riddle. If the selected button is showing the correct answer 204, 304, then in step 412, access is granted to the client computer for example access is granted to the server web site because the user has been determined to be a human user. The program ends in step 420.

However, if the user has clicked on a button showing one of the decoy strings 206,306, the user may be the automated agent and further evaluation is desirable. Control passes to step 414 to see if the display has been refreshed a predetermined number of times, in this example three times. If the display has been refreshed more than the predetermined number of times, then step 416 is executed in which a message is shown to the user that access is being denied to the user and the original display for example the Web address of the server computer 120 is displayed to the user and control passes to step 420. The user is assumed to be the automated agent.

However, in step 414, if the display has not been refreshed more than the predetermined number of times, then control passes to step 418. Here, a new riddle and answer are generated along with new decoy strings, and the display is refreshed to show the new riddle, new answer and new decoy strings to the user. Control now passes to step 408, and the process continues until the user presses the button with the answer or the number of refreshes is more than the predetermined number of times.

Although embodiments of the invention have been described in the foregoing detailed description and illustrated in the accompanying drawings, it will be understood that the invention is not limited to the embodiments disclosed, and particularly to network applications, but is capable of rearrangements, modifications, and substitution of parts and elements as well as use in numerous devices. The present invention is therefore intended to encompass such rearrangements, modifications and substitutions of parts and elements as fall within the spirit and scope of the invention.

1) A method for accepting an access request from a client computer connected to a server computer through a network, comprising the steps of:
receiving said access request for the server computer from the client computer;
generating a predetermined number of random characters to form a string in the server computer in response to the access request;
forming a decoy string of characters different than said riddle and an answer corresponding to said riddle;
placing said riddle on said display of an output device of said client computer;
placing said decoy string and said answer on buttons of a display of an output device of said client computer; and
determining if said answer to the riddle is correct.

2) A method for accepting an access request from a client computer connected to a server computer through a network as in claim 1 wherein the method includes the step of modifying at least one a attribute of the string of said random characters to form said riddle;

3) A method for accepting an access request from a client computer connected to a server computer through a network as in claim 1, wherein said display of said output device of said computer includes advertisement.

4) A method for accepting an access request from a client computer connected to a server computer through a network as in claim 1, wherein said display of said output device of said client computer is refreshed if said answer to the riddle is incorrect.

5) A method for accepting an access request from a client computer connected to a server computer through a network as in claim 4, wherein said riddle, said decoy string, and said answer are changed by said refresh of said display of said output device of said client computer.

6) A method for accepting an access request from a client computer connected to a server computer through a network as in claim 2, wherein said attribute is randomly selected fonts.

7) A method for accepting an access request from a client computer connected to a server computer through a network as in claim 2, wherein said attribute includes randomly selected sizes of characters.

8) A method for accepting an access request from a client computer connected to a server computer through a network as in claim 1, wherein a background of said button is randomized with a maze.

9) A method for accepting an access request from a client computer connected to a server computer through a network as in claim 1 wherein said button includes a button size which is randomly chosen.

10) A method for accepting an access request from a client computer connected to a server computer through a network, comprising the steps of:
receiving said access request for the server computer from the client computer;
generating a predetermined number of random characters to form a string in the server computer in response to the access request;
forming a decoy string of characters different than said riddle and an answer corresponding to said riddle;
placing said riddle on a list menu of said display of an output device of said client computer;
placing said decoy string and said answer on said list menu of a display of an output device of said client computer; and
determining if said answer to the riddle is correct.

11) A method for accepting an access request from a client computer connected to a server computer through a network as in claim 10 wherein the method includes the step of modifying at least one a attribute of the string of said random characters to form said riddle;

12) A method for accepting an access request from a client computer connected to a server computer through a network as in claim 10, wherein said display of said output device of said computer includes advertisement.

13) A method for accepting an access request from a client computer connected to a server computer through a network as in claim 10, wherein said display of said output device of said client computer is refreshed if said answer to the riddle is incorrect.

14) A method for accepting an access request from a client computer connected to a server computer through a network as in claim 13, wherein said riddle, said decoy string, and said answer are changed by said refresh of said display of said output device of said client computer.

15) A method for accepting an access request from a client computer connected to a server computer through a network as in claim 11, wherein said attribute is randomly selected fonts.

16) A method for accepting an access request from a client computer connected to a server computer through a network as in claim 11, wherein said attribute includes randomly selected sizes of characters.

17) A method for accepting an access request from a client computer connected to a server computer through a network as in claim 10, wherein a background of said list menu is randomized with a maze.

18) A method for accepting an access request from a client computer connected to a server computer through a network as in claim 1, wherein said Riddle and said answer do not match but said riddle and said answer are related to each other by a relationship.

19) A method for accepting an access request from a client computer connected to a server computer through a network as in claim 1 wherein said method is achieved with an extra click.
